(19) United States
(12) Patent Application Publication
(10) Pub. No.: US 2023/0126120 A1
(43) Pub. Date: Apr. 27, 2023

(54) SILVER NANOWIRE DISPERSION, SILVER NANOWIRE-CONTAINING CONDUCTOR, AND SILVER NANOWIRE-CONTAINING CONDUCTIVE LAMINATE

(71) Applicant: SEIKO PMC CORPORATION, Tokyo (JP)

(72) Inventors: Yasuhiro UETA, Chiba (JP); Tomoaki KAWAGUCHI, Chiba (JP)

(73) Assignee: SEIKO PMC CORPORATION, Tokyo (JP)

(21) Appl. No.: 18/009,737

(22) PCT Filed: Mar. 30, 2021
(86) PCT No.: PCT/JP2021/013599

§ 371 Date: Dec. 12, 2022

(30) Foreign Application Priority Data
Jun. 17, 2020 (JP) 2020-104789

(51) Int. Cl. C09D 5/24; C09D 7/61; C09D 7/40; C09D 7/63; C09D 7/20; C09D 139/06; C09D 101/28; H01B 1/22; H01B 5/14

(52) U.S. Cl. CPC C09D 5/24; C09D 7/61; C09D 7/67; C09D 7/70; C09D 7/63; C09D 7/20; C09D 139/06; C09D 101/284; H01B 1/22; H01B 5/14; C08K 2201/001; C08K 7/06

(57) ABSTRACT

In view of the problem with the prior art, the present invention addresses the following problems: providing a method that can suppress the generation of fine silver particles in a silver nanowire dispersion better than prior methods; and inhibiting, by a convenient method, particulation of silver nanowires on the anode side. A solution is a silver nanowire dispersion that contains silver nanowires, a dispersion solvent, and a chelating agent with the average diameter of the silver nanowires being not more than 100 nm, the silver nanowire dispersion being characterized in that the chelating agent content is 0.1 to 1,000 μmol/g with reference to the silver nanowire content, and the chelating agent is a prescribed aromatic heterocyclic compound having at least one imine skeleton in the molecule.

### TECHNICAL FIELD

The present invention relates to a silver nanowire dispersion characterized by containing a specific chelating agent, a silver nanowire-containing conductor containing a specific chelating agent, and a silver nanowire-containing conductive laminate containing a specific chelating agent.

### BACKGROUND ART

In recent years, there has been an increase in the utilization of display devices such as liquid crystal displays, plasma displays, organic electroluminescence displays, and electronic paper; input sensors such as touch panels; solar cells utilizing solar light such as thin-film type amorphous Si solar cells and dye-sensitized solar cells; and the like, and this also increases the demand for a transparent conductive film which is an indispensable member for these devices.

Conventionally, indium tin oxide (ITO) has been mainly used as a material of this transparent conductive film. Although high transparency and high conductivity are obtained in a thin film formed using ITO, the film is generally produced by a sputtering device or a vapor deposition device and thus has problems in terms of production speed and manufacturing cost. Furthermore, because indium, which is a raw material of ITO, is a rare metal of which stable supply is regarded as a problem, there is a demand for the development of alternative materials for ITO.

Metal nanowires are one example that has attracted attention as materials for transparent conductive films that can replace ITO. Metal nanowires have high optical transmittance in the visible light region because of their small diameters, making it possible to apply them as transparent conductive films. In particular, transparent conductive films formed using silver nanowires have attracted attention because of their high conductivity and stability.

In transparent conductive films using silver nanowires, the smaller the diameter of the silver nanowires, the more the light scattering is generally suppressed, thereby improving the optical characteristics of the film. For this reason, a manufacturing method of finer silver nanowires has been examined. For example, Patent Literature 1 reports a manufacturing method of silver nanowires with an average diameter of less than 30 nm and a low haze transparent conductor formed using the same.

However, the silver nanowires obtained in Patent Literature 1 are unstable due to their extremely small diameter, and it was found that there is a problem in that fine silver particles are gradually produced as a by-product over time in a silver nanowire dispersion, for example. Such fine silver particles scatter light in a film coated with silver nanowires, thereby deteriorating the optical characteristics of the film. Therefore, a method for solving such problems has been demanded.

Some proposals have been made for additives that improve the stability of silver nanowires. For example, Patent Literature 2 reports that the use of a pyridine-ketone compound suppresses an increase in the surface resistance value of a film coated with silver nanowires. Patent Literature 3 reports that the use of a heterocyclic compound having a specific interaction potential improves the thermal stability of a material to which silver nanowires have been applied. In addition, although some stabilizers for conductive films coated with silver nanowires against light and high-temperature and high-humidity conditions have been reported (for example, Patent Literature 4 to Patent Literature 8), additives that suppress the generation of fine silver particles in the state of a silver nanowire dispersion are not known.

In addition, it is known that in a conductive material formed using silver nanowires, a deterioration of silver nanowires typified by migration progresses due to the application of an electric field, and it can be confirmed that a deterioration due to the particulation of silver nanowires progresses on the anode side when actually applying an electric field. For this reason, techniques for preventing a deterioration of silver nanowires due to application of an electric field have been developed. For example, in Patent Literature 9, durability is improved by plating different metals on the surface of silver, but there is a problem in that a separate plating step is required, which complicates the process. Patent Literature 10 reports that migration resistance is improved by blending a low-molecular-weight compound having a urea bond into a silver nanowire ink, but only the presence or absence of a short circuit was evaluated. Therefore, there is a demand for a method that can suppress the particulation of silver nanowires on the anode side by simple means.

### CITATION LIST

### Patent Literature

### [Patent Literature 1]

Published Japanese Translation No. 2013-517603 of the PCT International Publication

### [Patent Literature 2]

United States Patent Application, Publication No. 2014/0255708

### [Patent Literature 3]

Japanese Patent Laid-Open No. 2010-086714

### [Patent Literature 4]

United States Patent Application, Publication No. 2015/0270024

### [Patent Literature 5]

Japanese Patent Laid-Open No. 2016-001608

### [Patent Literature 6]

Published Japanese Translation No. 2016-515280 of the PCT International Publication

### [Patent Literature 7]

Republished Japanese Translation No. 2018-008464 of the PCT International Publication for Patent Applications

### [Patent Literature 8]

Republished Japanese Translation No. 2018-116501 of the PCT International Publication for Patent Applications

### [Patent Literature 9]

Japanese Patent Laid-Open No. 2013-151752

### [Patent Literature 10]

Republished Japanese Translation No. 2019-198494 of the PCT International Publication for Patent Applications

### SUMMARY OF INVENTION

### Technical Problem

In view of the above-mentioned problem in the prior art, an objective of the present invention is to provide a method that can suppress the generation of fine silver particles in a silver nanowire dispersion better than prior methods and to inhibit particulation of silver nanowires on the anode side by a convenient method.

### Solution to Problem

As a result of intensive research aimed at achieving the above-mentioned objective, the inventors of the present invention found that the above-mentioned objective can be achieved by causing silver nanowires and a specific chelating agent to coexist, and thereby the present invention was completed.

That is, the present invention is as follows.

<1> A silver nanowire dispersion containing: silver nanowires; a dispersion solvent; and a chelating agent, in which an average diameter of the silver nanowires is 100 nm or less, the chelating agent is contained in an amount of 0.1 to 1,000 μmol/g with respect to a content of the silver nanowires, and the chelating agent is at least one selected from the group consisting of 1,10-phenanthroline, quinoline in which an 8-position is substituted with a hydroxyl group or an amino group, 2,2′-bipyridyl, a biazole (where the azole is any one of imidazole, thiazole, and oxazole), and a derivative thereof among aromatic heterocyclic compounds having at least one imine skeleton in a molecule.

<2> The silver nanowire dispersion according to <1>, in which the chelating agent is at least one selected from the group consisting of General Formulas (1) to (4).

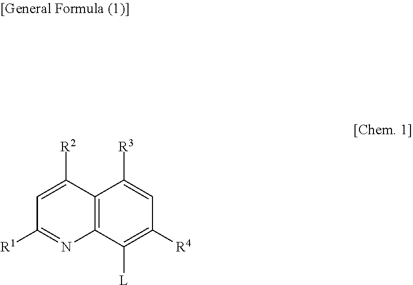

(in General Formula (1), L represents a hydroxyl group or an amino group; R¹ to R⁴ represent hydrogen, a linear alkyl group having 1 to 4 carbon atoms, or a halogen group; at least one of R² and R³ is hydrogen; and at least two of R¹ to R⁴ are hydrogen)

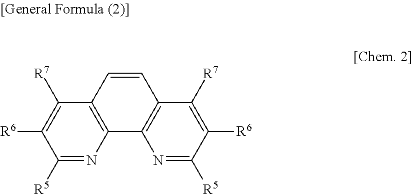

(in General Formula (2), R⁵ and R⁶ represent hydrogen, a linear alkyl group having 1 to 4 carbon atoms, or a halogen group; R⁷ represents hydrogen, a linear alkyl group having 1 to 4 carbon atoms, a phenyl group, a C₆H₄SO₃Na group, or a halogen group; and at least one of R⁵ to R⁷ is hydrogen)

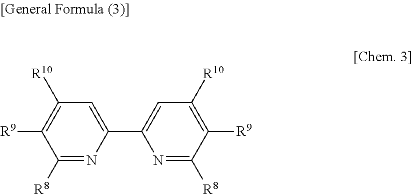

(in General Formula (3), R⁸ and R⁹ represent hydrogen, a linear alkyl group having 1 to 4 carbon atoms, or a halogen group; R¹⁰ represents hydrogen, an alkyl group having 1 to 4 carbon atoms, or a halogen group; and at least two of R⁸ to R¹⁰ are hydrogen)

Z¹—Z² [General Formula (4)]

(in General Formula (4), Z¹ and Z² each independently represent any of a nitrogen-containing heterocyclic ring represented by General Formula (5) or (6))

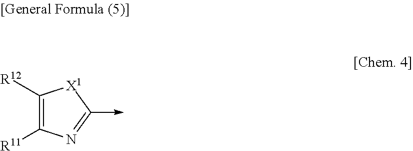

(in General Formula (5), X¹ represents any of NH, O, and S; R¹¹ and R¹² represent hydrogen, a linear alkyl group having 1 to 4 carbon atoms, a halogen group, or a co-forming benzene ring; and an arrow represents a single bond with Z¹ or Z²)

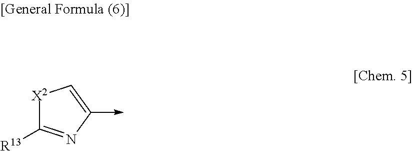

(in General Formula (6), X² represents any of NH, O, and S; R¹³ represents hydrogen, a linear alkyl group having 1 to 4 carbon atoms, or a halogen group; and an arrow represents a single bond with Z¹ or Z²)

<3> The silver nanowire dispersion according to <1> or <2>, in which a content of the chelating agent is 1 to 300 μmol/g with respect to the content of the silver nanowires.

<4> The silver nanowire dispersion according to any one of <1> to <3>, in which the chelating agent is at least one selected from the group consisting of 1,10-phenanthroline, neocuproine, bathophenanthroline and a sulfone sodium salt thereof, 2,2′-bipyridyl, 8-hydroxyquinoline, 8-aminoquinoline, and 2-(4-thiazolyl)benzimidazole.

<5> The silver nanowire dispersion according to any one of <1> to <4>, in which the average diameter of the silver nanowires is 30 nm or less.

<6> The silver nanowire dispersion according to any one of <1> to <5>, in which a concentration of the silver nanowires is 0.01% to 3% by mass.

<7> The silver nanowire dispersion according to any one of <1> to <6>, further containing a polymer compound selected from polymers having an amide bond, or polysaccharides, in which a concentration of the polymer compound is 0.02% to 1% by mass.

<8> The silver nanowire dispersion according to any one of <1> to <7>, in which the dispersion solvent contains any of water or monovalent alcohols having 1 to 3 carbon atoms, and a content of the water or the monovalent alcohols having 1 to 3 carbon atoms occupying the dispersion solvent is 85% by mass or more.

<9> A silver nanowire-containing conductor including: a substrate; and at least one silver nanowire-containing conductive layer, in which the conductive layer contains a chelating agent in an amount of 0.1 to 1,000 μmol/g with respect to a content of silver nanowires, and the chelating agent is at least one selected from the group consisting of 1,10-phenanthroline, quinoline in which an 8-position is substituted with a hydroxyl group or an amino group, 2,2′-bipyridyl, a biazole (where the azole is any one of imidazole, thiazole, and oxazole), and a derivative thereof among aromatic heterocyclic compounds having at least one imine skeleton in a molecule.

<10> The silver nanowire-containing conductor according to <9>, in which a sheet resistance of the conductive layer is 1 Ω/□ to 100 Ω/□.

<11> The silver nanowire-containing conductor according to <9> or <10>, in which a Δ haze is less than 1.5%.

<12> A silver nanowire-containing conductive laminate including: a substrate; a silver nanowire-containing conductive layer; and a protective layer containing a chelating agent, in which the chelating agent is at least one selected from the group consisting of 1,10-phenanthroline, quinoline in which an 8-position is substituted with a hydroxyl group or an amino group, 2,2′-bipyridyl, a biazole (where the azole is any one of imidazole, thiazole, and oxazole), and a derivative thereof among aromatic heterocyclic compounds having at least one imine skeleton in a molecule.

<13> The silver nanowire-containing conductive laminate according to <12>, in which the chelating agent is present in an amount of 0.05% to 5% by mass in the protective layer.

### Advantageous Effects of Invention

According to the present invention, by using a specific chelating agent, the generation of fine particles, which are the cause of a deterioration of optical characteristics, can be suppressed in a silver nanowire dispersion better than prior methods, and by using a chelating agent used in the present invention, the particulation in a silver nanowire-containing conductive layer when applying an electric field can be inhibited.

### DESCRIPTION OF EMBODIMENTS

The present invention will be described in detail hereinbelow.

[Silver Nanowire]

The term “silver nanowire” in the present invention refers to a silver structure in which a diameter is less than 1 μm and an aspect ratio (major axis length/diameter) is 2 or more. In addition, the term “fine particle” in the present invention refer to a structure in which a diameter is less than 1 μm and an aspect ratio (major axis length/diameter) is less than 2.

[Diameter of Silver Nanowire]

When silver nanowires are used as a transparent conductive film, it is advantageous and preferable for wires to have a small average diameter to increase transparency. The “diameter of silver nanowires” in the present invention refers to a diameter measured using a scanning electron microscope (SEM; JSM-5610LV manufactured by JEOL Ltd.). In addition, the “average diameter of silver nanowires” refers to an average value of diameters measured by observing 100 or more silver nanowires. In the present invention, the average diameter of the silver nanowires is preferably 100 nm or less, more preferably 40 nm or less, further preferably 30 nm or less, and particularly preferably 25 nm or less.

[Major Axis Length of Silver Nanowires]

A transparent conductive film containing silver nanowires exhibits conductivity when the silver nanowires come into contact with each other to form a three-dimensional conductive network structure that is spatially widely distributed, and therefore the average major axis length of the nanowires is preferably long from the viewpoint of conductivity. On the other hand, short nanowires are preferable from the viewpoint of dispersion stability because excessively long nanowires are likely to get entangled. The “major axis length of silver nanowires” in the present invention refers to a value obtained by imaging silver nanowires using a dark-field microscope (trade name: BX51, manufactured by Olympus Corporation) and calculating using image processing software (trade name: Image-Pro Premier, manufactured by Media Cybernetics, Inc.). In addition, the “average major axis length of silver nanowires” refers to an average value of major axis lengths measured by observing 1,000 or more silver nanowires. In the present invention, the average major axis length of silver nanowires is preferably 1 to 100 μm, more preferably 5 to 30 μm, and further preferably 7 to 20 μm.

[Manufacturing Method of Silver Nanowires]

There is no particular limitation on a manufacturing method of the silver nanowires used in the present invention, and those obtained by known manufacturing methods can be used. Among them, it is preferable to use a manufacturing method in which silver nanowires are obtained by reducing a silver salt in the presence of a growth regulating agent and a halide salt in a polyol.

[Polyol]

The above-mentioned polyol is not particularly limited as long as it is a compound capable of reducing silver ions, and at least one type can be appropriately selected from compounds having two or more hydroxyl groups depending on the purpose. Specific examples include diols such as ethylene glycol, propanediol, butanediol, and diethylene glycol, and triols such as glycerin. Among these, diols of saturated hydrocarbons having 1 to 5 carbon atoms and triols of saturated hydrocarbons having 1 to 5 carbon atoms are preferable from the viewpoint of being liquids and easiness of dissolving a growth regulating agent. Among them, ethylene glycol, 1,2-propanediol (propylene glycol), 1,3-propanediol, 1,3-butanediol, and glycerin are more preferably used, and propylene glycol is further preferably used.

[Growth Regulating Agent]

The growth regulating agent is not particularly limited, and at least one type of polymer can be appropriately selected depending on the purpose. Specific examples include polyvinylpyrrolidone, poly(meth)acrylamide, poly N-substituted (meth)acrylamide, poly(meth)acrylic acid and its derivatives, polyvinyl alcohol, and copolymers of these. Among these, polymers having an amide skeleton are preferable, polyvinylpyrrolidone, poly N-substituted (meth)acrylamide, or copolymers of these are more preferable, and polyvinylpyrrolidone is further preferable. The N-substituted (meth)acrylamide used herein is not particularly limited as long as it is one in which hydrogen atoms at the N-position of (meth)acrylamide have been substituted with one or more of a functional group such as an alkyl group, a hydroxyalkyl group, an aryl group, and an alkoxyalkyl group.

[Halide Salt]

The above-mentioned halide salt is not particularly limited as long as it is a compound from which halide ions dissociate when an inorganic salt or organic salt dissolves in a polar solvent, and at least one type can be appropriately selected according to the purpose. Specific examples of the halide salt include alkali metal halides such as lithium chloride, sodium chloride, potassium chloride, sodium bromide, and potassium bromide; alkaline earth metal halides such as magnesium chloride, calcium chloride, and magnesium bromide; earth metal halides such as aluminum chloride; zinc group metal halides such as zinc chloride; carbon group metal halides such as tin chloride; transition metal halides such as iron chloride, iron bromide, nickel chloride, and zirconium oxychloride; amine hydrochlorides such as triethylamine hydrochloride and dimethylethanolamine hydrochloride; ammonium salt halides such as ammonium chloride, ammonium bromide, tetrabutylammonium chloride, tetrabutylammonium bromide, benzyltriethylammonium chloride; and phosphonium salt halides such as tetrabutylphosphonium chloride. These may be used alone or may be used in combination of two or more types thereof. In particular, it is preferable to use chloride salts because the use of chloride salts increases the yield of silver nanowires, and it is more preferable to use both chloride salts and bromide salts because silver nanowires with a smaller diameter can be obtained by using bromide salts. As the chloride salts, lithium chloride, sodium chloride, potassium chloride, zirconium oxychloride, ammonium chloride, and benzyltriethylammonium chloride are preferably used, and sodium chloride is more preferably used. As the bromide salts, sodium bromide, potassium bromide, ammonium bromide, and tetrabutylammonium bromide are preferably used, and sodium bromide is more preferably used.

[Silver Salt]

The above-mentioned silver salt is not particularly limited as long as it is a silver compound that can be reduced by a polyol, and at least one type can be appropriately selected depending on the purpose. Specific examples include inorganic acid salts such as silver nitrate, silver sulfate, silver sulfamate, silver chlorate, and silver perchlorate, and organic acid salts such as silver acetate and silver lactate. Among these, it is preferable to use silver nitrate. The above-mentioned halide salt and silver salt may be used in combination in the same substance. Examples of such compounds include silver chloride and silver bromide.

[Purification of Silver Nanowires]

The silver nanowires obtained by the above-mentioned manufacturing method of silver nanowires are preferably made into a silver nanowire dispersion using a dispersion solvent after purifying a reaction solution by conventionally known methods such as a centrifugation method, a filtration method, a decantation method, an elutriation method, and a method of re-dispersing treatment after precipitation by a solvent.

[Silver Nanowire Dispersion]

The silver nanowire dispersion of the present invention is one in which silver nanowires have been dispersed in a dispersion solvent. Various additives can be used in combination in this silver nanowire dispersion as necessary to the extent that the effects of the invention are not impaired. Specific examples of additives include surfactants and polymer compounds.

[Concentration of Silver Nanowire Dispersion]

The concentration of silver nanowires of the silver nanowire dispersion used in the present invention can be set arbitrarily, but from the viewpoint of dispersion stability, the concentration is preferably 10% by mass or less, more preferably 5% by mass or less, further preferably 3% by mass or less, and particularly preferably 1% by mass or less. In addition, when the concentration of silver nanowires is extremely low, it is required to increase a coating thickness and perform multiple times of coating, which are much more time and effort when use, in order to set a desired resistance value at the time of coating. Therefore, from the viewpoint of productivity, the concentration is preferably 0.005% by mass or more, more preferably 0.01% by mass or more, and further preferably 0.05% by mass or more.

[Haze of Diluted Solution of Silver Nanowire Dispersion]

By measuring the haze of the silver nanowire dispersion with a specific concentration, the degree of light scattering when the silver nanowire dispersion is used as a coating film can be estimated. The “haze of the diluted solution of the silver nanowire dispersion” in the present invention refers to a value obtained by putting a diluted solution, which is obtained by setting a silver concentration of the silver nanowire dispersion to 0.0015% with ion-exchanged water, in a cell with an optical path length of 1 cm to measure the haze using NDH 5000 (manufactured by NIPPON DENSHOKU INDUSTRIES CO., LTD.). The haze of the diluted solution of the silver nanowire dispersion is preferably less than 10.0%, more preferably less than 5.0%, further preferably less than 3.0%, and particularly preferably 2.6% from the viewpoint of transparency when a film is formed from the dispersion.

[Dispersion Solvent]

The dispersion solvent used in the present invention may be any one as long as it is a compound that can disperse the silver nanowires and dissolve other components, such as polymer compounds, contained in the silver nanowire dispersion. In addition, because the silver nanowire dispersion is also used to create a silver nanowire-containing conductive layer, the dispersion solvent is preferably a compound that evaporates to form a uniform coating film at the time of forming the silver nanowire-containing conductive layer. Specific examples include alcohols such as water, methanol, ethanol, 1-propanol, 2-propanol, 1-butanol, 2-butanol, 2-methyl-1-propanol, 2-methyl-2-propanol, and diacetone alcohol; polyols such as ethylene glycol, propylene glycol, 1,3-propanediol, 1,3-butanediol, 1,4-butanediol, and glycerin; glycol ethers such as ethylene glycol monobutyl ether and propylene glycol monomethyl ether; glymes such as ethylene glycol dimethyl ether; glycol ether esters such as ethylene glycol monomethyl ether acetate; esters such as ethyl acetate and butyl acetate; ketones such as acetone and methyl ethyl ketone; aromatics such as toluene; and solvents composed of two or more types of these. Among them, it is preferable to use a polar solvent from the viewpoint of dispersibility of silver nanowires. Among them, the content of water or monovalent alcohols having 1 to 3 carbon atoms in the dispersion solvent is preferably 50% by mass or more, more preferably 75% by mass or more, and further preferably 85% by mass or more.

[Chelating Agent]

A chelating agent is a compound having an ability to coordinate to a single metal center at at least two different positions within the same molecule. In the present invention, among chelating agents, a specific aromatic heterocyclic compound having at least one imine skeleton in the molecule is used together with silver nanowires. An aromatic heterocyclic ring having an imine skeleton is an aromatic ring in which at least one carbon forming a ring of the aromatic ring such as benzene and furan has been replaced with nitrogen, and specific examples thereof include pyridine and oxazole. The chelating agent used in the present invention is a compound capable of chelating coordination with at least one heteroatom and imine-type nitrogen of an aromatic heterocyclic ring having at least one imine skeleton. The chelating agent having an aromatic heterocyclic ring structure having an imine skeleton is thought to exhibit the effects of the invention by stabilization due to a chelating effect and an appropriate coordinating ability of imine-type nitrogen contained in the heterocyclic ring structure with respect to silver. The positional relationship between the imine-type nitrogen having a coordinating ability and another heteroatom is also important, and a compound is preferable, the compound being capable of forming a chelate structure by disposition of the other heteroatom having a coordinating ability at a position three bonds away from the imine-type nitrogen of the aromatic heterocyclic ring. Among them, the structure of the chelating agent is preferably fixed to a structure capable of chelating coordination. In addition, a functional group having another heteroatom is important and is required to be any of a hydroxyl group, an amino group, or imine-type nitrogen. Among these, from the viewpoint of affinity for silver, an amino group or imine-type nitrogen is preferable, and imine-type nitrogen is more preferable. From the above description, the aromatic heterocyclic ring having an imine skeleton of the chelating agent that can be used in the present invention is at least one selected from the group consisting of 1,10-phenanthroline, quinoline in which an 8-position is substituted with a hydroxyl group or an amino group, 2,2′-bipyridyl, a biazole (where the azole is any of imidazole, thiazole, and oxazole), and a derivative thereof. Chelating agents having each aromatic heterocyclic ring structure will be described in detail below.

1,10-Phenanthroline and its derivatives are a compound group that can be most preferably used because both of heteroatoms capable of chelating coordination in the 1,10-phenanthroline skeleton are imine-type nitrogens and are fixed to a structure for chelating coordination. Preferable examples of 1,10-phenanthroline and its derivatives include a compound represented by General Formula (7).

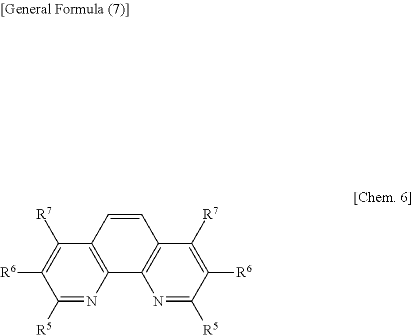

(in General Formula (7), R⁵ and R⁶ represent hydrogen, a linear alkyl group having 1 to 4 carbon atoms, or a halogen group; R⁷ represents hydrogen, a linear alkyl group having 1 to 4 carbon atoms, a phenyl group, a C₆H₄SO₃Na group, or a halogen group; and at least one of R⁵ to R⁷ is hydrogen)

Specific examples of these 1,10-phenanthrolines and their derivatives include 1,10-phenanthroline, neocuproine, 2,9-dibutyl-1,10-phenanthroline, 4,7-dimethyl-1,10-phenanthroline, 3,4,7,8-tetramethyl-1,10-phenanthroline, 2,9-dichloro-1,10-phenanthroline, 4,7-dichloro-1,10-phenanthroline, bathophenanthroline and its sulfone sodium salt, and bathocuproine and its sulfone sodium salt. Among these, from the viewpoint of availability, 1,10-phenanthroline, neocuproine, bathophenanthroline and its sulfone sodium salt are preferably used, and 1,10-phenanthroline is more preferably used. In addition, R⁵ in General Formula (7) is preferably hydrogen or a methyl group and is more preferably hydrogen because the smaller a substituent near a coordinating functional group, the more steric hindrance is alleviated, which is advantageous for interaction with silver.

Quinoline and its derivatives in which the 8-position has been substituted with a hydroxyl group or an amino group are compounds that can take a chelate structure with imine-type nitrogen and a hydroxyl group or an amino group and are fixed to a structure for chelating coordination. Preferable examples of quinoline and its derivatives include a compound represented by General Formula (8).

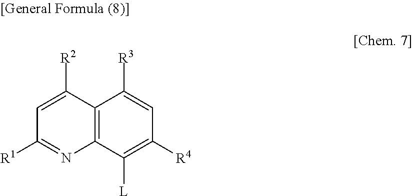

(in General Formula (8), L represents a hydroxyl group or an amino group; R¹ to R⁴ represent hydrogen, a linear alkyl group having 1 to 4 carbon atoms, or a halogen group; at least one of R² and R³ is hydrogen; and at least two of R¹ to R⁴ are hydrogen)

Specific examples of the quinoline and its derivatives in which the 8-position has been substituted with a hydroxyl group or an amino group include 8-hydroxyquinoline, 8-hydroxy-2-methylquinoline, 8-hydroxy-2-propylquinoline, 5-fluoro-8-hydroxyquinoline, 5-chloro-8-hydroxyquinoline, 7-bromo-5-chloro-8-hydroxyquinoline, 8-aminoquinoline, and 8-amino-2-methylquinoline. Among these, from the viewpoint of availability, 8-hydroxyquinoline, 8-hydroxy-2-methylquinoline, 5-chloro-8-hydroxyquinoline, and 8-aminoquinoline are preferably used, and 8-hydroxyquinoline and 8-aminoquinoline is more preferably used. In addition, R¹ in General Formula (8) is preferably hydrogen or a methyl group and is more preferably hydrogen because the smaller a substituent near a coordinating functional group, the more steric hindrance is alleviated, which is advantageous for interaction with silver. From the viewpoint of interaction with silver, L in General Formula (8) is more preferably an amino group.

In 2,2′-bipyridyl and its derivatives, because the pyridyl groups of the 2,2′-bipyridyl skeleton are connected via one single bond so that they can rotate freely around this bond axis, 2,2′-bipyridyl and its derivatives can be preferably used because two heteroatoms capable of chelating coordination are both imine-type nitrogens although a structure for chelating coordination is not fixed. Examples in which 2,2′-bipyridyl and its derivatives can be preferably used include a compound represented by General Formula (9).

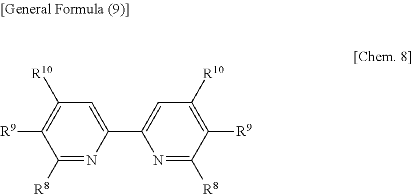

(in General Formula (9), R⁸ and R⁹ represent hydrogen, a linear alkyl group having 1 to 4 carbon atoms, or a halogen group; R¹⁰ represents hydrogen, an alkyl group having 1 to 4 carbon atoms, or a halogen group; and at least two of R⁸ to R¹⁰ are hydrogen)

Specific examples of these 2,2′-bipyridyls and their derivatives include 2,2′-bipyridyl, 4,4′-dimethyl-2,2′-bipyridyl, 5,5′-dimethyl-2,2′-bipyridyl, 6,6′-dimethyl-2,2′-bipyridyl, 4,4′-dibromo-2,2′-bipyridyl, 6,6′-dibromo-2,2′-bipyridyl, and 4,4′-di-tert-butyl-2,2′-bipyridyl. Among these, 2,2′-bipyridyl is preferably used from the viewpoint of availability. In addition, R⁸ in General Formula (9) is preferably hydrogen or a methyl group and is more preferably hydrogen because the smaller a substituent near a coordinating functional group, the more steric hindrance is alleviated, which is advantageous for interaction with silver.

In general, a biazole is a compound in which two azoles are bonded via a single bond, but a biazole referred to in the present invention refers to one in which each azole (wherein the azole is any of imidazole, thiazole, and oxazole) is bonded to another azole at the 2-position or the 4-position to form a biazole skeleton. In a biazole and its derivatives, because the azole groups of the biazole skeleton are connected via one single bond so that they can rotate freely around this bond axis, a structure for chelating coordination is not fixed as in the case of 2,2′-bipyridyl. However, a biazole, in which 5-membered rings are bonded to each other via a single bond, is more preferably used than 2,2′-bipyridyl and its derivatives because the steric hindrance between the two rings is small when the two rings are coplanar to form a structure preferable for chelating coordination, and thereby the structure preferable for chelating coordination can be more stably present, as compared to 2,2′-bipyridyl in which 6-membered rings are bonded to each other via a single bond. Furthermore, the above-mentioned biazole can be preferably used because both of heteroatoms capable of chelating coordination are imine-type nitrogens. Examples in which the biazole and its derivatives can be preferably used include a compound represented by General Formula (10).

Z¹—Z² [General Formula (10)]

(in General Formula (10), Z¹ and Z² each independently represent any of a nitrogen-containing heterocyclic ring represented by General Formula (11) or (12))

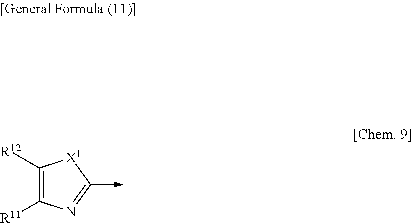

(in General Formula (11), X¹ represents any of NH, O, and S; R¹¹ and R¹² represent hydrogen, a linear alkyl group having 1 to 4 carbon atoms, a halogen group, or a co-forming benzene ring; and an arrow represents a single bond with Z¹ or Z²)

Among these, R¹¹ in General Formula (11) is preferably hydrogen or a benzene ring formed together with R¹² because the smaller a substituent near a coordinating functional group, the more steric hindrance is alleviated, which is advantageous for interaction with silver.

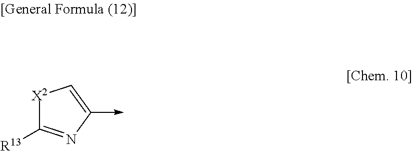

(in General Formula (12), X² represents any of NH, O, and S; R¹³ represents hydrogen, a linear alkyl group having 1 to 4 carbon atoms, or a halogen group; and an arrow represents a single bond with Z¹ or Z²)

Among these, R¹³ in General Formula (12) is preferably hydrogen or a methyl group and is more preferably hydrogen because the smaller a substituent near a coordinating functional group, the more steric hindrance is alleviated, which is advantageous for interaction with silver. Specific examples of these biazoles and their derivatives include 2-(4-thiazolyl)benzimidazole, 2,2′-biimidazole, 2,2′-bis-(4,5-dimethylimidazole), and 2,2′-dimethyl-4,4′-bithiazole. Among these, 2-(4-thiazolyl)benzimidazole is preferably used from the viewpoint of availability.

[Content of Chelating Agent in Silver Nanowire Dispersion]

By adding the chelating agent defined in the present invention to the silver nanowire dispersion, the generation of fine particles over time can be suppressed in the silver nanowire dispersion. Because the generation of fine particles can be suppressed as the amount of the chelating agent used in the present invention increases, the amount of the chelating agent contained in the silver nanowire dispersion is required to be 0.1 μmol/g or more with respect to the silver nanowires. Among them, the amount is preferably 0.5 μmol/g or more, more preferably 1 μmol/g or more, further preferably 2 μmol/g or more, and particularly preferably 5 μmol/g or more. On the other hand, the use amount of the chelating agent is preferably small from the viewpoint of conductivity and dispersibility of the silver nanowires. For this reason, the amount of the chelating agent to be used is preferably 1,000 μmol/g or less, more preferably 300 μmol/g or less, and further preferably 100 μmol/g or less with respect to the silver nanowires.

[Polymer Compound]

It is preferable to add a polymer compound to the silver nanowire dispersion of the present invention for the purpose of improving the dispersion stability of the silver nanowires and improving coating suitability. Specific examples of polymer compounds include polysaccharides and their derivatives such as methylcellulose, ethylcellulose, hydroxyethylcellulose, hydroxypropylcellulose, hydroxypropylmethylcellulose, carboxymethylcellulose, nitrocellulose, cellulose acetate, guar gum, xanthan gum, tamarind seed gum, psyllium seed gum, ghatti gum, locust bean gum, hydroxyethyl guar gum, and hydroxypropyl guar gum, poly(meth)acrylic resins, polyurethane resins, polyester resins, alkyd resins, epoxy resins, ethylene vinyl acetate resins, poly-N-vinyl compounds such as polyvinylpyrrolidone, poly(meth)acrylamide, poly N-substituted (meth)acrylamide, and polyvinyl alcohols and their derivatives. Among them, it is preferable to use polysaccharides and their derivatives, and polymers having an amide bond. Among polysaccharides and their derivatives, methylcellulose, ethylcellulose, hydroxyethylcellulose, hydroxypropylcellulose, and hydroxypropylmethylcellulose are preferable, and hydroxypropylmethylcellulose is more preferable. Among the polymers having an amide bond, poly N-substituted (meth)acrylamide and polyvinylpyrrolidone are preferable, and polyvinylpyrrolidone is more preferable.

[Concentration of Polymer Compound]

The concentration of the polymer compound contained in the silver nanowire dispersion is preferably 0.005% by mass or more, more preferably 0.02% by mass or more, and further preferably 0.05% by mass from the viewpoint of improving the dispersibility of the silver nanowires and coating suitability. From the viewpoint of the conductivity of a coating film, the content of the polymer compound is preferably 5% by mass or less, more preferably 1% by mass or less, and further preferably 0.4% by mass or less.

[Formation of Silver Nanowire-Containing Conductive Layer Using Silver Nanowire Dispersion]

For example, the silver nanowire dispersion of the present invention can be used for forming a silver nanowire-containing conductive layer, and the silver nanowire-containing conductive layer is obtained by application on a substrate by a known method. Specific examples of application methods include a spin coating method, a slit coating method, a dip coating method, a blade coating method, a bar coating method, a spraying method, a letterpress printing method, an intaglio printing method, a screen printing method, a lithographic printing method, a dispensing method, and an ink jet method. In addition, application may be performed multiple times using these application methods.

[Silver Nanowire-Containing Conductor]

A silver nanowire-containing conductor is a conductor having a substrate and the silver nanowire-containing conductive layer.

[Silver Nanowire-Containing Conductive Laminate]

A silver nanowire-containing conductive laminate is a laminate having at least one substrate, one silver nanowire-containing conductive layer, and one protective layer. The silver nanowire-containing conductive layer can be created by forming a film from the silver nanowire dispersion. In addition, the protective layer can be created by forming a film from a protective layer-forming resin composition. In the present invention, the silver nanowire-containing conductive layer and/or the protective layer can contain the chelating agent, and when at least one of the silver nanowire-containing conductive layer and the protective layer contains the chelating agent defined in the present invention, the particulation of silver nanowires when applying an electric field can be inhibited.

[Lamination Method]

A manufacturing method of the silver nanowire-containing conductive laminate is not particularly limited. Examples thereof include a method in which a film is formed on a substrate from a silver nanowire dispersion to form a silver nanowire-containing conductive layer, and a protective layer is further formed on the upper surface thereof, and a method in which a protective layer is formed in advance on a substrate, and a silver nanowire-containing conductive layer and a protective layer are formed thereon in order.

[Substrate]

The substrate is appropriately selected according to usage applications, and may be rigid or flexible. In addition, the substrate may be colored. As the substrate in the present invention, any one can be used without particular limitation as long as it is a substrate that can be obtained by a known method or is commercially available. Specific examples of materials of the substrate include glass, polyimide, polycarbonate, polyethersulfone, polyacrylate, polyester, polyethylene terephthalate, polyethylene naphthalate, polyolefin, and polyvinyl chloride. An organic functional material and an inorganic functional material may be further formed on the substrate. In addition, a large number of substrates may be laminated.

[Silver Nanowire-Containing Conductive Layer]

The silver nanowire-containing conductive layer is a layer containing silver nanowires. The silver nanowire-containing conductive layer can be created by forming a film from the silver nanowire dispersion. As the silver nanowire dispersion, known one can be used, but one containing the chelating agent defined in the present invention is preferable.

[Sheet Resistance of Silver Nanowire-Containing Conductive Layer]

The sheet resistance of the silver nanowire-containing conductive layer is used as an index of the conductivity of the silver nanowire-containing conductor or the silver nanowire-containing conductive laminate. The sheet resistance of the silver nanowire-containing conductive layer can be arbitrarily set according to the intended usage application by changing the amount of silver nanowires contained in the above-mentioned conductive layer. The range of the sheet resistance that can be preferably used is 0.1 Ω/□ to 1,000 Ω/□, and more preferably 1 Ω/□ to 100 Ω/□.

[Protective Layer]

The protective layer is formed from the protective layer-forming resin composition and is provided mainly for the purpose of physically and chemically protecting the silver nanowire-containing conductive layer. The protective layer may be disposed adjacent to the silver nanowire-containing conductive layer, or a plurality of layers may be provided between the protective layer and the conductive layer. The protective layer is preferably disposed adjacent to the silver nanowire-containing conductive layer from the viewpoint of protecting the silver nanowire-containing conductive layer.

[Protective Layer-Forming Resin Composition]

The protective layer-forming resin composition is a composition composed of a photopolymerization initiator and/or a thermal polymerization initiator, and a polymerizable monomer and/or a macromonomer. The protective layer-forming resin composition may further contain a chelating agent, a weather resistance improving agent, a solvent, a curing aid, and other additives to be described later, if necessary. In the present invention, when the protective layer of the silver nanowire-containing conductive laminate is formed using the protective layer-forming resin composition containing the chelating agent defined in the present invention, the particulation of silver nanowires when applying an electric field can be inhibited.

[Formation of Protective Layer]

A known application method can be used as an application method of the protective layer-forming resin composition. Specific examples of application methods include a spin coating method, a slit coating method, a dip coating method, a blade coating method, a bar coating method, a spraying method, a letterpress printing method, an intaglio printing method, a screen printing method, a lithographic printing method, a dispensing method, and an ink jet method. In addition, application may be performed multiple times using these application methods.

[Content of Chelating Agent in Protective Layer]

By adding the chelating agent defined in the present invention to the silver nanowire-containing conductive laminate, the particulation of silver nanowires when applying an electric field can be inhibited. Because the larger the amount of the chelating agent used in the protective layer of the silver nanowire-containing conductive laminate, the more the particulation can be inhibited, the amount of the chelating agent contained in the protective layer is preferably 0.01% by mass or more, more preferably 0.05% by mass or more, further preferably 0.1% by mass or more, and particularly preferably 0.2% by mass or more. On the other hand, a small use amount of the chelating agent is thought to be preferable from the viewpoint of conductivity. Accordingly, the amount of the chelating agent contained in the protective layer is preferably 15% by mass or less, more preferably 7% by mass or less, further preferably 5% by mass or less, and particularly preferably 2% by mass or less. The amount of the chelating agent contained in the protective layer can be obtained from the amount of the chelating agent with respect to the amount of components excluding a solvent among the components contained in the protective layer-forming resin composition.

[Photopolymerization Initiator]

The photopolymerization initiator is not particularly limited and may be a photopolymerization initiator that is obtained by a known method or is commercially available. Specific examples of the photopolymerization initiator include 1-hydroxycyclohexyl phenyl ketone, diethoxyacetophenone, 2-hydroxy-2-methyl-1-phenylpropan-1-one, 1-[4-(2-hydroxyethoxy)-phenyl]-2-hydroxy-2-methyl-1-propan-1-one, benzoin, benzoin methyl ether, benzoin ethyl ether, benzoylbenzoic acid, methyl benzoylbenzoate, 2-methyl-1-[4-(methylthio)phenyl]-2-(4-morpholinyl)-1-propanone, xanthone, anthraquinone, and 2-methylanthraquinone. These can be used alone or in combination of two or more types thereof.

[Thermal Polymerization Initiator]

The thermal polymerization initiator is not particularly limited and may be a thermal polymerization initiator that is obtained by a known method or is commercially available. Specific examples of the thermal polymerization initiator include persulfuric acid salts such as ammonium persulfate, sodium persulfate, and potassium persulfate; peroxides such as t-butyl hydroperoxide, cumene hydroperoxide, benzoyl peroxide, and lauroyl peroxide; redox initiators obtained by combining persulfuric acid salts and peroxides with reducing agents such as sulfurous acid salts, bisulfite salts, thiosulfuric acid salts, sodium formaldehyde sulfoxylate, ferrous sulfate, ferrous ammonium sulfate, glucose, and ascorbic acid; and azo compounds such as 2,2′-azobisisobutyronitrile, 2,2′-azobis(2,4-dimethylvaleronitrile), 2,2′-azobis(2-methylbutyronitrile), 2,2′-azobis(2-methylpropionate)dimethyl, and 2,2′-azobis(2-amidinopropane)dihydrochloride. These can be used alone or in combination of two or more types thereof.

[Polymerizable Monomer and Macromonomer]

The polymerizable monomer and the macromonomer are not particularly limited as long as they are monomers and macromonomers that directly undergo a polymerization reaction by irradiation with visible light or ionizing radiation such as ultraviolet rays or electron beams or undergo a polymerization reaction under the action of an initiator. Specific examples of polymerizable monomers having one polymerizable unsaturated group in one molecule include (meth)acrylic esters such as (meth)acrylic acid, methyl (meth)acrylate, ethyl (meth)acrylate, butyl (meth)acrylate, 2-ethylhexyl (meth)acrylate, cyclohexyl (meth)acrylate, phenoxyethyl (meth)acrylate, 2-hydroxyethyl (meth)acrylate, methoxy-diethylene glycol (meth)acrylate, and methoxy-triethylene glycol (meth)acrylate; (meth)allyl compounds such as (meth)allyl alcohol and glycerol mono(meth)allyl ether; aromatic vinyls such as styrene, methylstyrene, and butylstyrene; carboxylic acid vinyl esters such as vinyl acetate; and (meth)acrylamides such as (meth)acrylamide, N-cyclohexyl (meth)acrylamide, N-phenyl (meth)acrylamide, and N-(2-hydroxyethyl) (meth)acrylamide. Furthermore, specific examples of polymerizable monomers having two or more polymerizable unsaturated groups in one molecule include polyethylene glycol di(meth)acrylate, trimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, dipentaerythritol hexa(meth)acrylate, alkyl-modified dipentaerythritol (meth)acrylate, ethylene oxide-modified bisphenol A di(meth)acrylate, ethylene oxide-modified trimethylolpropane tri(meth)acrylate, propylene oxide-modified trimethylolpropane tri(meth)acrylate, and ethylene oxide-modified isocyanuric acid tri(meth)acrylate. As specific examples of the macromonomer, a polymerizable urethane acrylate resin, a polymerizable polyurethane resin, a polymerizable acrylic resin, a polymerizable epoxy resin, and a polymerizable polyester resin, all of which have an average of 1 or more polymerizable unsaturated groups per molecule, can be used. These can be used alone or in combination of two or more types thereof.

[Weather Resistance Improving Agent]

From the viewpoint of temporal stability, the protective layer-forming resin composition preferably contains a weather resistance improving agent. The weather resistance improving agent is a compound that functions to inhibit the deterioration of silver nanowires in the environment. As such a weather resistance improving agent, known one can be used. Among them, it is preferable to use in combination with a compound represented by General Formula (13) or (14), and it is more preferable to use in combination with a compound selected from 2-mercaptothiazoline, 2-mercaptobenzothiazole, 2-mercaptobenzothiazole methyl ether, 3-(1,3-benzothiazol-2-ylthio)propionic acid, and (1,3-benzothiazol-2-ylthio)succinic acid.

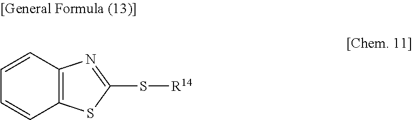

(in General Formula (13), R¹⁴ represents a hydrogen atom, an alkyl group having 1 to 12 carbon atoms, or a (di)carboxyalkyl group having an alkyl group having 1 to 3 carbon atoms)

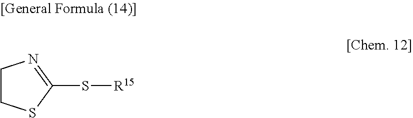

(in General Formula (14), R¹⁵ represents a hydrogen atom, an alkyl group having 1 to 12 carbon atoms, or a (di)carboxyalkyl group having an alkyl group having 1 to 3 carbon atoms)

[Solvent for Protective Layer-forming Resin Composition]

The protective layer-forming resin composition may further contain a solvent. It is sufficient for the solvent to be a compound that dissolves other components in the resin composition and evaporates at the time of film formation to form a uniform coating film. Specific examples of solvents include water, methanol, ethanol, 1-propanol, 2-propanol, acetone, methyl ethyl ketone, toluene, n-hexane, n-butyl alcohol, diacetone alcohol, methyl isobutyl ketone, methyl butyl ketone, ethyl butyl ketone, cyclohexanone, ethyl acetate, butyl acetate, propylene glycol monomethyl ether acetate, ethylene glycol monoethyl ether, propylene glycol monomethyl ether, diethylene glycol diethyl ether, diethylene glycol ethyl methyl ether, 1,3-butylene glycol diacetate, cyclohexanol acetate, propylene glycol diacetate, tetrahydrofurfuryl alcohol, and N-methyl-2-pyrrolidone. These can be used alone or in combination of two or more types thereof.

[Curing Aid]

The protective layer-forming resin composition may further contain a curing aid. It is sufficient for the curing aid to be a compound having two or more reactive functional groups in one molecule. Specific examples of reactive functional groups include an isocyanate group, an acryloyl group, a methacryl group, and a mercapto group. These can be used alone or in combination of two or more types thereof.

[Other Additives]

Various additives can be added to the protective layer-forming resin composition within a range not impairing the effects of the present invention. As additives, for example, organic fine particles, flame retardants, flame retardant aids, oxidation stabilizers, leveling agents, slip activators, antistatic agents, dyes, fillers, and the like can be used.

The silver nanowire-containing conductor of the present invention and the silver nanowire-containing conductive laminate of the present invention can be widely applied to various devices such as electrode materials for liquid crystal displays, electrode materials for plasma displays, electrode materials for organic electroluminescence displays, electrode materials for electronic paper, electrode materials for touch panels, electrode materials for thin-film type amorphous Si solar cells, electrode materials for dye-sensitized solar cells, electromagnetic-wave shielding materials, and antistatic materials.

### EXAMPLES

Hereinafter, the present invention will be specifically described based on examples, but the present invention is not limited to these examples.

The abbreviation of each drug in the tables means the following.

Phen: 1,10-phenanthroline monohydrate

Neoc: neocuproine 0.5 hydrate

Batho: disodium bathophenanthroline disulfonic acid hydrate

bpy: 2,2′-bipyridyl

8-HQ: 8-hydroxyquinoline

8-AQ: 8-aminoquinoline

TBZ: 2-(4-thiazolyl)benzimidazole

HPBO: 2-(2-hydroxyphenyl)benzoxazole

box: 2,2′-(2-bisoxazoline)

DAcPy: 2,6-diacetylpyridine

HEPy: 2-pyridine ethanol

Im: imidazole

ImA: 4-imidazolecarboxylic acid

MBI: 2-mercaptobenzimidazole

IPA: 2-propanol

HPMC-1: hydroxypropyl methylcellulose (METHOCEL 311 manufactured by Dow Chemical Company)

HPMC-2: hydroxypropyl methylcellulose (METOLOSE (registered trademark) 60SH-10000 manufactured by Shin-Etsu Chemical Co., Ltd.)

MBT: 2-mercaptobenzothiazole

DETA: diethylenetriamine

4,4′-bpy: 4,4′-bipyridyl

<Creation of Silver Nanowires>

### Synthesis Example 1

While feeding nitrogen into a four-necked flask equipped with a stirrer, a thermometer, and a nitrogen introduction tube, 666.97 parts by mass of a propylene glycol solution of 1.0% by mass polyvinylpyrrolidone (Sokalan (registered trademark) K90P manufactured by BASF), 5.35 parts by mass of a propylene glycol solution of sodium chloride with a concentration of 1.5% by mass, 1.87 parts by mass of a propylene glycol solution of sodium bromide with a concentration of 2.2% by mass, and 162.95 parts by mass of propylene glycol were added and stirred at room temperature for 30 minutes. Subsequently, after raising the internal temperature to 145° C., a solution obtained by mixing and dissolving 1.06 parts by mass of 2,5-dimethyl-4-hydroxy-3(2H)-furanone, 4.80 parts by mass of ion-exchanged water, and 30 parts by mass of propylene glycol was added and stirred for 10 minutes. Thereafter, while maintaining the internal temperature at 145° C., 127 parts by mass of a propylene glycol solution of silver nitrate at a concentration of 5.5% by mass was added over 90 minutes and further stirred for 30 minutes. Thereafter, the obtained solution was cooled to obtain a reaction solution containing silver nanowires.

[Preparation of Silver Nanowire Dispersion (a)]

1,000 parts by mass of the reaction solution containing silver nanowires was diluted by adding 3,000 parts by mass of water thereto, and suction filtration was performed with a membrane filter. Furthermore, water was added to the residue, suction filtration was repeated five times, and water was added again to obtain a silver nanowire dispersion of 0.15% by mass crude particles. The obtained crude silver nanowire dispersion was treated with a centrifuge at a rotation speed of 2,000 rpm for 10 minutes, and the remaining supernatant was collected to remove silver nanowires having a relatively large diameter. The obtained supernatant solution was concentrated using a membrane filter to prepare a silver nanowire dispersion (a) having a content of 0.7% by mass. The obtained silver nanowires had an average major axis length of 12 μm and an average diameter of 25 nm.

[Stability Test of Silver Nanowire Dispersion]

In the stability test of the silver nanowire dispersion, the stability was evaluated by leaving the silver nanowire dispersion to stand at 40° C. for 10 days, measuring the haze of the diluted solution of the obtained silver nanowire dispersion, and obtaining the increase rate of the haze compared to the silver nanowire dispersion immediately after preparation. Specifically, the haze increase rate was given by (1) Formula. As for the haze increase rate, the lower the value, the smaller the degree of deterioration of optical characteristics, because the generation of fine silver particles is suppressed due to changes over time. NDH 5000 (manufactured by NIPPON DENSHOKU INDUSTRIES CO., LTD.) was used for the measurement.

(H2−H1)/H1×100 (%) (1)

H1: the haze of the diluted solution of the silver nanowire dispersion immediately after preparation

H2: the haze of the diluted solution of the silver nanowire dispersion left to stand at 40° C. for 10 days

The haze increase rate is preferably less than 15%, more preferably less than 12%, further preferably less than 7%, and particularly preferably less than 4%.

### Example A-1

7.14 parts by mass of the 0.7% by mass silver nanowire dispersion (a), 0.10 parts by mass of an aqueous solution of 5% by mass polyvinylpyrrolidone (manufactured by BASF, Sokalan (registered trademark) K30P), 0.10 parts by mass of an aqueous solution of 0.1% by mass 1,10-phenanthroline monohydrate, 0.10 parts by mass of ethanol, and 2.56 parts by mass of ion-exchanged water were added to a plastic container and mixed with a shaker for 5 minutes after closing the lid, and thereby a 0.5% by mass silver nanowire dispersion (A-1) was prepared. The haze of the diluted solution of the prepared silver nanowire dispersion (A-1) was 2.27%. Table 1 shows the results of the stability test of the prepared silver nanowire dispersion (A-1).

### Examples A-2 to A-19 and Comparative Examples A-1 to A-8

The stability test of silver nanowire dispersions was performed in the same manner as in Example A-1 except that the conditions for Examples A-2 to A-19 and Comparative Examples A-1 to A-8 were changed as shown in Table 1. The results are also collectively shown in Table 1. The amount of substance of the disodium bathophenanthroline disulfonic acid hydrate was calculated as a dihydrate.

TABLE 1

| | | | | Amount of substance | | |
|---|---|---|---|---|---|---|
| | Silver | | | with respect to mass | | |
| | nanowire | Chelating agent | | of silver nanowires | | |
| | Concentration | | Concentration | of chelating agent | | Haze increase |
| | (% by mass) | Type | (ppm) | (μmol/g) | Dispersion solvent | rate (%) |
| Example A-1 | 0.5 | Phen | 10.0 | 10.1 | Aqueous solution of 1% by mass ethanol | 1.3 |
| Example A-2 | 0.5 | Phen | 20.0 | 20.2 | Aqueous solution of 1% by mass ethanol | Less than 1% |
| Example A-3 | 0.5 | Phen | 90.0 | 90.8 | Aqueous solution of 1% by mass ethanol | Less than 1% |
| Example A-4 | 0.5 | Phen | 5.0 | 5.0 | Aqueous solution of 1% by mass ethanol | 3.5 |
| Example A-5 | 0.5 | Phen | 2.0 | 2.0 | Aqueous solution of 1% by mass ethanol | 6.1 |
| Example A-6 | 0.65 | Phen | 10.0 | 7.8 | Water | 1.3 |
| Example A-7 | 0.5 | bpy | 7.9 | 10.1 | Aqueous solution of 1% by mass ethanol | 5.7 |
| Example A-8 | 0.5 | 8-HQ | 7.3 | 10.1 | Aqueous solution of 1% by mass ethanol | 2.9 |
| Example A-9 | 0.5 | TBZ | 10.2 | 10.1 | Aqueous solution of 5% by mass ethanol | 1.8 |
| Example A-10 | 0.5 | Neoc | 11.0 | 10.1 | Aqueous solution of 1% by mass ethanol | 2.2 |
| Example A-11 | 0.5 | Batho | 28.9 | 10.1 | Aqueous solution of 1% by mass ethanol | 1.5 |
| Example A-12 | 0.5 | 8-AQ | 7.3 | 10.1 | Aqueous solution of 1% by mass ethanol | 2.0 |
| Example A-13 | 0.6 | bpy | 39.4 | 42.0 | Aqueous solution of 1% by mass ethanol | Less than 1% |
| Example A-14 | 0.5 | TBZ | 2.0 | 2.0 | Aqueous solution of 5% by mass ethanol | 7.9 |
| Example A-15 | 0.5 | Neoc | 2.2 | 2.0 | Aqueous solution of 1% by mass ethanol | 9.3 |
| Example A-16 | 0.5 | 8-AQ | 1.5 | 2.0 | Aqueous solution of 1% by mass ethanol | 8.8 |
| Example A-17 | 0.5 | bpy | 1.6 | 2.0 | Aqueous solution of 1% by mass ethanol | 10.6 |
| Example A-18 | 0.5 | Phen | 0.5 | 0.5 | Aqueous solution of 1% by mass ethanol | 14.1 |
| Example A-19 | 0.5 | Phen | 1.0 | 1.0 | Aqueous solution of 1% by mass ethanol | 11.5 |
| Comparative Example A-1 | 0.5 | Not contained | — | — | Aqueous solution of 1% by mass ethanol | 35.1 |
| Comparative Example A-2 | 0.5 | DAcPy | 8.2 | 10.1 | Aqueous solution of 1% by mass ethanol | 32.7 |
| Comparative Example A-3 | 0.5 | ImA | 5.7 | 10.1 | Aqueous solution of 1% by mass ethanol | 19.8 |
| Comparative Example A-4 | 0.5 | Im | 3.4 | 10.1 | Aqueous solution of 1% by mass ethanol | 22.1 |
| Comparative Example A-5 | 0.5 | HPBO | 10.7 | 10.1 | Aqueous solution of 5% by mass ethanol | 26.6 |
| Comparative Example A-6 | 0.5 | box | 7.1 | 10.1 | Aqueous solution of 1% by mass ethanol | 23.9 |
| Comparative Example A-7 | 0.5 | HEPy | 6.2 | 10.1 | Aqueous solution of 1% by mass ethanol | 27.9 |
| Comparative Example A-8 | 0.5 | Phen | 0.04 | 0.040 | Aqueous solution of 1% by mass ethanol | 28.2 |

### Example B-1

[Creation of Silver Nanowire-Containing Conductor]

5.71 parts by mass of the 0.7% by mass silver nanowire dispersion (a), 2.40 parts by mass of an aqueous solution of 0.5% by mass hydroxypropylmethylcellulose (METHOCEL 311 manufactured by Dow Chemical Company), 0.08 parts by mass of an aqueous solution of 0.1% by mass of 1,10-phenanthroline monohydrate, 9.81 parts by mass of ion-exchanged water, and 2.0 parts by mass of 2-propanol were put in a plastic container and mixed with a shaker for 5 minutes after closing the lid, and thereby a silver nanowire dispersion (B-1) having a silver nanowire concentration of 0.2% by mass was prepared. The silver nanowire dispersion (B-1) was uniformly applied onto a polyethylene terephthalate film (PET film, manufactured by Toray Industries, Inc., trade name “Lumirror U403”) having a film thickness of 100 μm using a wire bar No. 7, and drying was performed with a hot air convection dryer at 120° C. for 2 minutes to create a silver nanowire-containing conductor. Table 2 shows the results of measuring the physical properties of the created conductor.

### Examples B-2 to B-11 and Comparative Examples B-1 to B-4

Measurement of physical properties was performed by creating silver nanowire-containing conductors in the same manner as in Example B-1 except that the conditions for Examples B-2 to B-11 and Comparative Examples B-1 to B-4 were changed as shown in Table 2. The results are also collectively shown in Table 2.

[Sheet Resistance of Silver Nanowire-Containing Conductor]

The sheet resistance (Ω/□) at 9 different sites on the silver nanowire-containing conductor was measured, and from the arithmetic mean value thereof, the average sheet resistance of the conductive layer in the silver nanowire-containing conductor was obtained. A non-contact type surface resistivity measurement instrument EC-80P (manufactured by Napson Corporation) was used to measure the sheet resistance. Furthermore, in order to estimate the influence of the chelating agent on the sheet resistance, the sheet resistance change rate of the conductive layer of the silver nanowire-containing conductor containing the chelating agent with respect to the silver nanowire-containing conductor not containing the chelating agent was obtained. The sheet resistance change rate is given by Formula (2). A smaller value of the sheet resistance change rate indicates that an increase in the sheet resistance due to the chelating agent is suppressed.

(r2−r1)/r1×100 (%) (2)

r1: the average sheet resistance of the conductive layer in the silver nanowire-containing conductor not containing the chelating agent

r2: the average sheet resistance of the conductive layer in the silver nanowire-containing conductor containing the chelating agent

The sheet resistance change rate is preferably less than 30%, more preferably less than 20%, further preferably less than 15%, and particularly preferably less than 10%.

[Total Light Transmittance of Silver Nanowire-Containing Conductor]

Using NDH 5000 (manufactured by NIPPON DENSHOKU INDUSTRIES CO., LTD.), the total light transmittance of the silver nanowire-containing conductor was measured. Furthermore, the difference in total light transmittance between the silver nanowire-containing conductor and a substrate before coating was calculated by the following formula and was defined as a Δ total light transmittance.

Δ Total light transmittance (%)=total light transmittance of silver nanowire-containing conductor−total light transmittance of substrate before coating

The smaller the absolute value of the Δ total light transmittance, the better it is, and the absolute value of the Δ total light transmittance is preferably 10% or less, and more preferably 5% or less.

[Haze of Silver Nanowire-Containing Conductor]

Using NDH 5000 (manufactured by NIPPON DENSHOKU INDUSTRIES CO., LTD.), the haze of the silver nanowire-containing conductor was measured. Furthermore, the difference in haze between the silver nanowire-containing conductor and a substrate before coating was calculated by the following formula and was defined as a haze.

Δ Haze (%)=haze of silver nanowire-containing conductor−haze of substrate before coating

The smaller the value of the Δ haze, the better it is, and the value of the Δ haze is preferably 3.0% or less, more preferably 1.5% or less, and further preferably 1.0% or less.

TABLE 2

| | | | | Amount of | | | | | | | |
|---|---|---|---|---|---|---|---|---|---|---|---|
| | Silver | | | substance | | | | | Absolute | | Sheet |
| | nanowire | | | with respect to | Polymer | | | | value of | | resist- |
| | Concen- | Chelating agent | | amount of silver | compound | | | Sheet | Δ total | | ance |
| | tration | | Concen- | nanowires of | | Concen- | | resis- | light trans- | Δ | change |
| | (% by | | tration | chelating agent | | tration | | tance | mittance | Haze | rate |
| | mass) | Type | (ppm) | (μmol/g) | Type | (ppm) | Dispersion solvent | (Ω/□) | (%) | (%) | (%) |
| Example B-1 | 0.2 | Phen | 4.0 | 10.1 | HPMC-1 | 600 | Aqueous solution of 10% | 38 | 2.4 | 0.75 | −7 |
| | | | | | | | by mass IPA | | | | |
| Example B-2 | 0.2 | Phen | 20.0 | 50.4 | HPMC-1 | 600 | Aqueous solution of 10% | 40 | 2.2 | 0.74 | −2 |
| | | | | | | | by mass IPA | | | | |
| Example B-3 | 0.2 | Phen | 100 | 252 | HPMC-1 | 600 | Aqueous solution of 10% | 43 | 2.4 | 0.72 | 5 |
| | | | | | | | by mass IPA | | | | |
| Example B-4 | 0.2 | bpy | 3.2 | 10.1 | HPMC-1 | 600 | Aqueous solution of 10% | 38 | 2.2 | 0.73 | −7 |
| | | | | | | | by mass IPA | | | | |
| Example B-5 | 0.2 | bpy | 15.8 | 50.6 | HPMC-1 | 600 | Aqueous solution of 10% | 40 | 2.2 | 0.73 | −2 |
| | | | | | | | by mass IPA | | | | |
| Example B-6 | 0.2 | 8-HQ | 2.9 | 10.1 | HPMC-1 | 600 | Aqueous solution of 10% | 39 | 2.3 | 0.73 | −5 |
| | | | | | | | by mass IPA | | | | |
| Example B-7 | 0.2 | 8-HQ | 14.6 | 50.3 | HPMC-1 | 600 | Aqueous solution of 10% | 46 | 2.3 | 0.73 | 12 |
| | | | | | | | by mass IPA | | | | |
| Example B-8 | 0.2 | TBZ | 4.1 | 10.1 | HPMC-1 | 600 | Aqueous solution of 10% | 40 | 2.3 | 0.65 | −2 |
| | | | | | | | by mass IPA | | | | |
| Example B-9 | 0.2 | TBZ | 20.4 | 50.7 | HPMC-1 | 600 | Aqueous solution of 10% | 48 | 2.1 | 0.67 | 17 |
| | | | | | | | by mass IPA | | | | |
| Example B-10 | 0.2 | Phen | 4.0 | 10.1 | HPMC-2 | 2000 | Aqueous solution of 10% | 37 | 2.3 | 0.87 | −10 |
| | | | | | | | by mass IPA | | | | |
| Example B-11 | 0.3 | Phen | 10.0 | 16.8 | HPMC-1 | 600 | Aqueous solution of 10% | 22 | 3.8 | 0.97 | −4 |
| | | | | | | | by mass IPA | | | | |
| Comparative | 0.2 | Not | — | — | HPMC-1 | 600 | Aqueous solution of 10% | 41 | 2.1 | 0.73 | Stan- |
| Example B-1 | | contained | | | | | by mass IPA | | | | dard |
| Comparative | 0.2 | Phen | 500 | 1261 | HPMC-1 | 600 | Aqueous solution of 10% | 75 | 8.9 | 3.43 | 83 |
| Example B-2 | | | | | | | by mass IPA | | | | |
| Comparative | 0.3 | Not | — | — | HPMC-1 | 600 | Aqueous solution of 10% | 23 | 3.9 | 1.09 | Stan- |
| Example B-3 | | contained | | | | | by mass IPA | | | | dard |
| Comparative | 0.3 | MBI | 22.8 | 50.6 | HPMC-1 | 600 | Aqueous solution of 10% | 40 | 4.0 | 1.19 | 74 |
| Example B-4 | | | | | | | by mass IPA | | | | |

### Example C-1

[Preparation of Silver Nanowire Dispersion]

3.43 parts by mass of the 0.7% by mass silver nanowire dispersion (a), 1.20 parts by mass of an aqueous solution of 0.5% by mass hydroxypropylmethylcellulose (METHOCEL 311 manufactured by Dow Chemical Company), 3.87 parts by mass of ion-exchanged water, and 1.5 parts by mass of 2-propanol were put in a plastic container and mixed with a shaker for 5 minutes after closing the lid, and thereby a silver nanowire dispersion (C-1a) having a silver nanowire concentration of 0.24% by mass was prepared.

[Preparation of Silver Nanowire-Containing Conductor]

The silver nanowire dispersion (C-1a) was uniformly applied onto a polyethylene terephthalate film (PET film, manufactured by Toray Industries, Inc., trade name “Lumirror U403”) having a film thickness of 100 μm using a wire bar No. 7, and drying was performed with a hot air convection dryer at 120° C. for 2 minutes to prepare a silver nanowire-containing conductor (C-1b).

[Preparation of Protective Layer-Forming Resin Composition]

15 parts by mass of dipentaerythritol hexaacrylate as a polymerizable monomer and a macromonomer, 5 parts by mass of trimethylolpropane triacrylate, 0.8 parts by mass of 1-hydroxycyclohexylphenyl ketone as a polymerization initiator, 0.042 parts by mass of 1,10-phenanthroline monohydrate, and 80 parts by mass of propylene glycol monomethyl ether as a solvent were put in a four-necked flask and stirred until a uniform solution was obtained, and thereby a protective layer-forming resin composition (C-1c) was prepared.

[Formation of Silver Nanowire-Containing Conductive Laminate]

The protective layer-forming resin composition (C-1c) was diluted 4-fold with propylene glycol monomethyl ether and uniformly applied onto the silver nanowire-containing conductor (C-1b) by a spin coating method (4,000 rpm for 30 seconds). After drying with a hot air convection dryer at 80° C. for 2 minutes, the PET substrate was irradiated with UV light from above under the conditions of 500 mJ/cm2 using an ultraviolet irradiation device UV1501C-SZ (manufactured by Sen Engineering Co., Ltd.) to form a protective layer for the silver nanowire layer, and thereby a silver nanowire-containing conductive laminate (C-1d) was obtained. The amount of the chelating agent contained in the protective layer created using the protective layer-forming resin composition (C-1c) was 0.042/(15+5+0.8+0.042)×100=0.2% by mass.

[Electric Field Applied High Temperature and High Humidity Test]

The created silver nanowire-containing conductive laminate was cut into a dimension of 3 cm long×10 cm wide, and a non-conductive portion having a width of about 30 μm was formed at a position of 5 cm wide with a cutter. Subsequently, in a glass substrate (manufactured by AS ONE Corporation, slide glass made from soda glass) which was bonded by peeling off a separator on one side, an optical elastic resin (manufactured by 3M Co., Ltd., trade name 8146-2, film thickness 50 μm) was bonded to the remaining other side by peeling off a separator on the other side so that the optical elastic resin was disposed on the upper surface of the silver nanowire-containing conductive laminate and the both ends of the silver nanowire-containing conductive laminate stuck out, and thereby a sample piece in which the silver nanowire-containing conductive laminate, the optical elastic resin, and the glass were laminated in this order on the PET film was obtained. Subsequently, using a tester, it was confirmed that the current did not flow at both ends by sandwiching the non-conductive portion of the sample piece. Thereafter, 3 AA batteries were connected in series to both ends of the sample piece with the non-conductive portion sandwiched therebetween, and by leaving the sample piece to stand in this state in an environment of 85° C. and 85% RH for 10 hours, the electric field applied high temperature and high humidity test was performed using a constant temperature and constant humidity tester (manufactured by ISUZU Seisakusho Co., Ltd, TPAV-48-20). By observing the sample piece after the test using a dark-field microscope (trade name: BX51, manufactured by Olympus Corporation), a portion in which the particulation progressed from the non-conductive portion toward the positive electrode side of the battery and silver nanowires disappeared could be confirmed. The distance of the region in which the silver nanowires disappeared from the non-conductive portion was measured at 9 points at equal intervals, and the average value thereof was calculated and taken as the average value of the particulation distance. Table 3 shows the results. Herein, the smaller the average value of the particulation distance, the better it is, and the average value is preferably 220 mm or less, more preferably 200 mm or less, and further preferably 175 mm or less.

### Examples C-2 to C-9 and Comparative Examples C-1 to C-4

Measurement of physical properties was performed by creating silver nanowire-containing conductive laminates in the same manner as in Example C-1 except that the conditions for Examples C-2 to C-9 and Comparative Examples C-1 to C-4 were changed as shown in Table 3. The results are also collectively shown in Table 3.

TABLE 3

| | | | | Protective layer | | | | |
|---|---|---|---|---|---|---|---|---|
| | Conductive layer | | | Chelating agent | | Weather resistance improving agent | | |
| | Silver | | | | Amount of | | Amount of weather | Average |
| | nanowire | Chelating agent | | | chelating agent | | resistance improving | value of |
| | Concen- | | Concen- | | contained in | | agent contained in | particulation |
| | tration | | tration | | protective layer | | protective layer | distance |
| | (% by mass) | Type | (ppm) | Type | (% by mass) | Type | (% by mass) | (mm) |
| Example C-1 | 0.24 | Not contained | — | Phen | 0.2 | Not contained | — | 172 |
| Example C-2 | 0.24 | Not contained | — | Phen | 2.0 | Not contained | — | 161 |
| Example C-3 | 0.24 | Phen | 20.0 | Not contained | — | Not contained | — | 199 |
| Example C-4 | 0.24 | Phen | 20.0 | Phen | 2.0 | MBT | 1.6 | 168 |
| Example C-5 | 0.24 | Not contained | — | Phen | 5.0 | Not contained | — | 162 |
| Example C-6 | 0.24 | Not contained | — | Phen | 0.02 | Not contained | — | 183 |
| Example C-7 | 0.24 | Not contained | — | bpy | 0.2 | Not contained | — | 179 |
| Example C-8 | 0.24 | Not contained | — | TBZ | 0.2 | Not contained | — | 150 |
| Example C-9 | 0.24 | Not contained | — | 8-AQ | 0.2 | Not contained | — | 164 |
| Comparative | 0.24 | Not contained | — | Not contained | | Not contained | — | 258 |
| Example C-1 | | | | | | | | |
| Comparative | 0.24 | Not contained | — | Not contained | — | MBT | 1.6 | 237 |
| Example C-2 | | | | | | | | |
| Comparative | 0.24 | Not contained | — | Not contained | — | DETA | 0.2 | 268 |
| Example C-3 | | | | | | | | |
| Comparative | 0.24 | Not contained | — | Not contained | — | 4,4′-bpy | 0.2 | 221 |
| Example C-4 | | | | | | | | |

Since Examples A-1 to A-19 contained a certain amount or more of the chelating agent defined in the present invention, it was found that the increase in haze due to change over time was suppressed as compared to Comparative Example 1 in which the chelating agent was not contained.

On the other hand, as compared to Examples A-1 to A-19 in which the chelating agent defined in the present invention was contained, it was found that the effect of suppressing the increase in haze due to change over time was insufficient in Comparative Example A-2 using 2,6-diacetylpyridine exemplified as a pyridine-ketone compound in Patent Literature 2 was used, Comparative Example A-3 using 4-imidazolecarboxylic acid exemplified as a heterocyclic compound having a specific interaction potential in Patent Literature 3, and Comparative Examples A-4 to A-7 using heterocyclic compounds having a structure different from the structures defined in the present invention.

As compared to Examples A-1 to A-6, A-18, and A-19, it was found that the effect of suppressing the increase in haze due to change over time was insufficient in Comparative Example A-8 because the amount of substance of the chelating agent contained in the silver nanowire dispersion with respect to the silver nanowires was outside the range defined by the present invention.

As compared to Example A-18, it was found that the increase in haze could be further suppressed in Examples A-1 to A-6 and A-19 because the amount of substance of the chelating agent contained in the silver nanowire dispersion with respect to the silver nanowires was in a more preferable range.

Since a specified amount or less of the chelating agent defined in the present invention was contained in Examples B-1 to B-11, the same sheet resistance value as those of Comparative Examples B-1 and B-3 in which the content of silver nanowires was same and the chelating agent was not contained was shown, and it was found that the adverse effect on conductivity was small. However, in Comparative Example B-2 in which a specified amount or more was used, a significant increase in sheet resistance was confirmed as compared to Comparative Example B-1. From these results, it was found that it is required to use a specified amount or less of the chelating agent defined in the present invention.

On the other hand, it was found that Comparative Example B-4, in which 2-mercaptobenzimidazole exemplified as a heterocyclic compound having a specific interaction potential in Patent Literature 3 was used cannot be preferably used because an increase in sheet resistance was significant and the adverse effect on conductivity was large, as compared to Comparative Example B-3.

Since the chelating agent defined in the present invention was contained in Examples C-1 to C-9, it was found that the region in which particulation occurred when applying an electric field was smaller, indicating that the resistance was improved, as compared to Comparative Example C-1 in which the chelating agent defined in the present invention was not contained.

On the other hand, in Comparative Examples C-2 to C-4 using compounds having a structure different from the structures defined in the present invention, it was found that there is almost no effect of reducing the region in which particulation occurred when applying an electric field, indicating that the effect of suppressing a deterioration when applying an electric field is limited, as compared to Comparative Example C-1.

1. A silver nanowire dispersion comprising:
silver nanowires;
a dispersion solvent; and
a chelating agent,
wherein an average diameter of the silver nanowires is 100 nm or less,
the chelating agent is contained in an amount of 0.1 to 1,000 μmol/g with respect to a content of the silver nanowires, and
the chelating agent is at least one selected from the group consisting of 1,10-phenanthroline, quinoline in which an 8-position is substituted with a hydroxyl group or an amino group, 2,2′-bipyridyl, a biazole, where the azole is any one of imidazole, thiazole, and oxazole, and a derivative thereof among aromatic heterocyclic compounds having at least one imine skeleton in a molecule,
wherein the dispersion solvent contains any of water or monovalent alcohols having 1 to 3 carbon atoms, and
a content of the water or the monovalent alcohols having 1 to 3 carbon atoms occupying the dispersion solvent is 85% by mass or more.

2. The silver nanowire dispersion according to claim 1,
wherein the chelating agent is at least one selected from the group consisting of General Formulas (1) to (4), 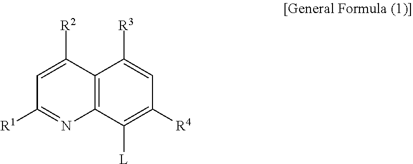
in General Formula (1), L represents a hydroxyl group or an amino group; R¹ to R⁴ represent hydrogen, a linear alkyl group having 1 to 4 carbon atoms, or a halogen group; at least one of R² and R³ is hydrogen; and at least two of R¹ to R⁴ are hydrogen, 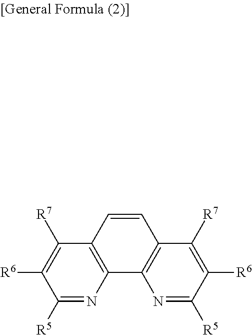
in General Formula (2), R⁵ and R⁶ represent hydrogen, a linear alkyl group having 1 to 4 carbon atoms, or a halogen group; R⁷ represents hydrogen, a linear alkyl group having 1 to 4 carbon atoms, a phenyl group, a C₆H₄SO₃Na group, or a halogen group; and at least one of R⁵ to R⁷ is hydrogen, 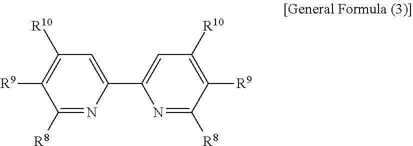
in General Formula (3), R⁸ and R⁹ represent hydrogen, a linear alkyl group having 1 to 4 carbon atoms, or a halogen group; R¹⁰ represents hydrogen, an alkyl group having 1 to 4 carbon atoms, or a halogen group; and at least two of R⁸ to R¹⁰ are hydrogen,
Z¹—Z² [General Formula (4)]
in General Formula (4), Z¹ and Z² each independently represent any of a nitrogen-containing heterocyclic ring represented by General Formula (5) or (6), 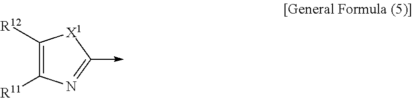
in General Formula (5), X¹ represents any of NH, O, and S; R¹¹ and R¹² represent hydrogen, a linear alkyl group having 1 to 4 carbon atoms, a halogen group, or a co-forming benzene ring; and an arrow represents a single bond with Z¹ or Z², and 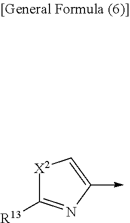
in General Formula (6), X² represents any of NH, O, and S; R¹³ represents hydrogen, a linear alkyl group having 1 to 4 carbon atoms, or a halogen group; and an arrow represents a single bond with Z¹ or Z².

3. The silver nanowire dispersion according to claim 1, wherein a content of the chelating agent is 1 to 300 μmol/g with respect to the content of the silver nanowires.

4. The silver nanowire dispersion according to claim 1, wherein the chelating agent is at least one selected from the group consisting of 1,10-phenanthroline, neocuproine, bathophenanthroline and a sulfone sodium salt thereof, 2,2′-bipyridyl, 8-hydroxyquinoline, 8-aminoquinoline, and 2-(4-thiazolyl)benzimidazole.

5. The silver nanowire dispersion according to claim 1, wherein the average diameter of the silver nanowires is 30 nm or less.

6. The silver nanowire dispersion according to claim 1, wherein a concentration of the silver nanowires is 0.01% to 3% by mass.

7. The silver nanowire dispersion according to claim 1, further comprising
a polymer compound selected from polymers having an amide bond, or polysaccharides,
wherein a concentration of the polymer compound is 0.02% to 1% by mass.

8. (canceled)

9. A silver nanowire-containing conductor comprising:
a substrate; and
at least one silver nanowire-containing conductive layer,
wherein the conductive layer contains a chelating agent in an amount of 0.1 to 1,000 μmol/g with respect to a content of silver nanowires, and
the chelating agent is at least one selected from the group consisting of 1,10-phenanthroline, quinoline in which an 8-position is substituted with a hydroxyl group or an amino group, 2,2′-bipyridyl, a biazole where the azole is any one of imidazole, thiazole, and oxazole, and a derivative thereof among aromatic heterocyclic compounds having at least one imine skeleton in a molecule.

10. The silver nanowire-containing conductor according to claim 9, wherein a sheet resistance of the conductive layer is 1 Ω/□ to 100 Ω/□.

11. The silver nanowire-containing conductor according to claim 9, wherein a Δ haze is less than 1.5%.

12. A silver nanowire-containing conductive laminate comprising:
a substrate;
a silver nanowire-containing conductive layer; and
a protective layer containing a chelating agent,
wherein the chelating agent is at least one selected from the group consisting of 1,10-phenanthroline, quinoline in which an 8-position is substituted with a hydroxyl group or an amino group, 2,2′-bipyridyl, a biazole where the azole is any one of imidazole, thiazole, and oxazole, and a derivative thereof among aromatic heterocyclic compounds having at least one imine skeleton in a molecule.

13. The silver nanowire-containing conductive laminate according to claim 12, wherein the chelating agent is present in an amount of 0.05% to 5% by mass in the protective layer.
